(19) United States
(12) Patent Application Publication
(10) Pub. No.: US 2022/0166939 A1
(43) Pub. Date: May 26, 2022

(54) INFORMATION PROCESSING APPARATUS, METHOD, AND RECORDING MEDIUM

(71) Applicant: SONY GROUP CORPORATION, TOKYO (JP)

(72) Inventors: TSUYOSHI ISHIKAWA, TOKYO (JP); RYOUHEI YASUDA, KANAGAWA (JP); KEI TAKAHASHI, TOKYO (JP); JUNICHI SHIMIZU, TOKYO (JP); TAKAYOSHI SHIMIZU, TOKYO (JP)

(21) Appl. No.: 17/310,902

(22) PCT Filed: Mar. 6, 2020
(86) PCT No.: PCT/JP2020/009834

§ 371 Date: Aug. 30, 2021

(30) Foreign Application Priority Data
Mar. 13, 2019 (JP) 2019-046427

(51) Int. Cl. H04N 5/268; H04N 5/232; H04N 5/247; G06T 17/00; B64C 39/02; B64D 47/08

(52) U.S. Cl. CPC H04N 5/268; H04N 5/23296; H04N 5/247; G06T 17/00; B64C 2201/127; H04N 5/23203; B64C 39/024; B64D 47/08; H04N 5/23216

(57) ABSTRACT

An information processing apparatus according to one example of the present disclosure includes an imaging control unit that causes a first imaging apparatus to acquire a real video while moving at least one of a viewpoint and a line of sight in accordance with a movement instruction given by a user, and a video generation unit that, when the first imaging apparatus approaches an imaging disapproved region that is set as a region in which imaging by the first imaging apparatus is disapproved while moving at least one of the viewpoint and the line of sight in accordance with the movement instruction, generates a video in which the real video is continuously switched to a virtual video of an inside of the imaging disapproved region.

### FIELD

The present disclosure relates to an information processing apparatus, a method, and a recording medium.

### BACKGROUND

A technology in which a virtual video in an arbitrary viewpoint (and a line of sight) in a space is acquired from real videos that are collected from a plurality of viewpoints (and lines of sight) in the space by a real camera has been studied.

### CITATION LIST

### Patent Literature

Patent Literature 1: International Publication No. WO/2016/088437

### SUMMARY

### Technical Problem

The virtual video as described above can freely be acquired from an arbitrary viewpoint (and a line of sight), but is only a calculated video that is obtained by calculation from the real videos, and, therefore, quality thereof may be reduced as compared to the real videos.

In contrast, the real videos are acquired in accordance with imaging performed by the real camera that exists in real life, and, therefore, quality thereof tends to increase as compared to the virtual video. However, the real camera is not able to acquire real videos in an imaging disapproved region that is set as a region in which imaging by the real camera is disapproved, such as a region in which there is a risk of contact with an object, for example.

Therefore, to improve quality of a series of videos corresponding to an arbitrary viewpoint (and a line of sight) during an arbitrary period in an arbitrary region (space) including the imaging disapproved region, it is desired to effectively use a real video and a virtual video.

In view of the above, the present disclosure proposes an information processing apparatus, a method, and a recording medium capable of effectively using a real video and a virtual video.

### Solution to Problem

Information processing device as an example of the present disclosure includes: an imaging control unit that causes a first imaging apparatus to acquire a real video while moving at least one of a viewpoint and a line of sight in accordance with a movement instruction given by a user; and a video generation unit that, when the first imaging apparatus approaches an imaging disapproved region, the imaging disapproved region being set as a region in which imaging by the first imaging apparatus is disapproved, while moving at least one of the viewpoint and the line of sight in accordance with the movement instruction, generates a video in which the real video is continuously switched to a virtual video of an inside of the imaging disapproved region.

### BRIEF DESCRIPTION OF DRAWINGS

FIG. 1 is an exemplary and schematic diagram illustrating an example of application of a technology according to an embodiment of the present disclosure.

FIG. 2 is an exemplary and schematic block diagram illustrating functions of an information processing apparatus according to the embodiment of the present disclosure.

FIG. 3 is an exemplary and schematic diagram illustrating an example of a setting screen for setting a movement instruction according to the embodiment of the present disclosure.

FIG. 4 is an exemplary and schematic diagram illustrating an example of an imaging disapproved region according to the embodiment of the present disclosure.

FIG. 5 is an exemplary and schematic diagram illustrating an example of a configuration of a series of videos according to the embodiment of the present disclosure.

FIG. 6 is an exemplary and schematic diagram illustrating an example of control that is performed at the time of switching from a virtual video to a real video according to the embodiment of the present disclosure.

FIG. 7 is an exemplary and schematic flowchart illustrating the flow of a process that is performed when the information processing apparatus according to the embodiment of the present disclosure generates an imaging plan.

FIG. 8 is an exemplary and schematic flowchart illustrating the flow of a process that is performed when the information processing apparatus according to the embodiment of the present disclosure generates a series of videos in accordance with the imaging plan.

FIG. 9 is an exemplary and schematic diagram illustrating an example of application of the technology according to the embodiment of the present disclosure, which is different from FIG. 1.

FIG. 10 is an exemplary and schematic diagram illustrating an example of application of the technology according to the embodiment of the present disclosure, which is different from FIG. 1 and FIG. 9.

FIG. 11 is an exemplary and schematic block diagram illustrating an example of a hardware configuration of a computer that implements functions of the information processing apparatus according to the embodiment of the present disclosure.

### DESCRIPTION OF EMBODIMENTS

Embodiments of the present disclosure will be described below based on the drawings. Configurations of the embodiments described below, and operational results (effects) derived from the configurations are merely one example, and not limited to the descriptions below.

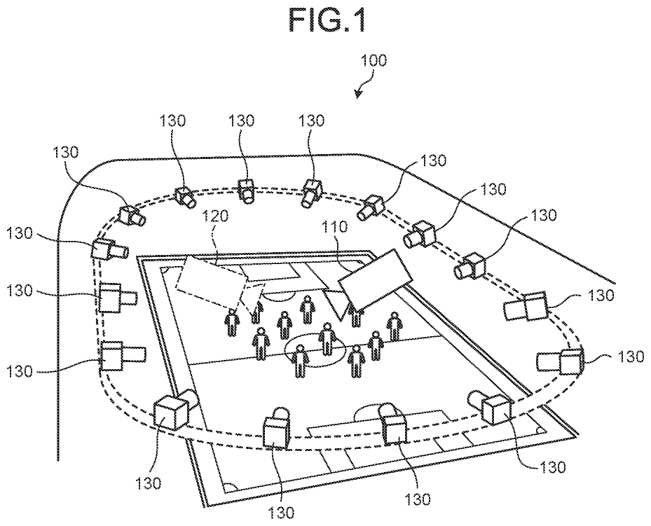

FIG. 1 is an exemplary and schematic diagram illustrating an example of application of a technology according to an embodiment of the present disclosure. As illustrated in FIG. 1, the technology according to the embodiment is applied to, for example, a situation in which an imaging apparatus 110 and a plurality of imaging apparatuses 130 capture images of a sports competition held at a competition site 100. The imaging apparatus 110 is one example of a “first imaging apparatus”, and the imaging apparatuses 130 are one example of a “second imaging apparatus”.

The imaging apparatus 110 is configured as a real camera that is able to freely move inside the competition site 100. For example, the imaging apparatus 110 is configured as a drone that is an air vehicle equipped with a camera. Meanwhile, in the embodiment, the imaging apparatus 110 may be a crane including a camera that is arranged at a distal end of the crane. Meanwhile, only the single imaging apparatus 110 is present in the example illustrated in FIG. 1, but the technology according to the embodiment is also applicable to a case in which the plurality of imaging apparatuses 110 are present and the plurality of imaging apparatuses 110 are configured to be movable independently of each other.

Further, the plurality of imaging apparatuses 130 are configured as real cameras that are arranged so as to surround the competition site 100. Real videos acquired by the plurality of imaging apparatuses 130 are used to generate a three-dimensional model of a space in the competition site 100, in other words, an imaging target space that is captured by the imaging apparatus 110. It is possible to acquire, from the three-dimensional model, a virtual video what is called a free viewpoint video that is viewed in an arbitrary line of sight from an arbitrary viewpoint in the competition site 100.

Meanwhile, an imaging apparatus 120 as a virtual camera that acquires a virtual video is illustrated for the sake of convenience in the example illustrated in FIG. 1, but the imaging apparatus 120 is only a virtual apparatus and does not really exist. Further, in the embodiment, it is possible to use a real video acquired by the imaging apparatus 110 to generate the three-dimensional model, instead of or in addition to the real videos acquired by the imaging apparatuses 130.

Meanwhile, the virtual video as described above can freely be generated from an arbitrary viewpoint (and a line of sight), but is a calculated video that is generated based on the three-dimensional model, and, therefore, quality thereof tends to decrease as compared to the real video.

In contrast, the real video is acquired in accordance with imaging performed by the imaging apparatus 110 as the real camera that really exists, and, therefore, the quality thereof tends to increase as compared to the virtual video. However, the imaging apparatus 110 as the real camera is not able to acquire a real video in an imaging disapproved region that is set as a region in which imaging by the real camera is disapproved, such as a region in which there is a risk of contact with an object, for example.

Therefore, to improve quality of a series of videos corresponding to an arbitrary viewpoint (and a line of sight) during an arbitrary period in an arbitrary region (space) including the imaging disapproved region, it is desired to effectively use a real videos and a virtual video.

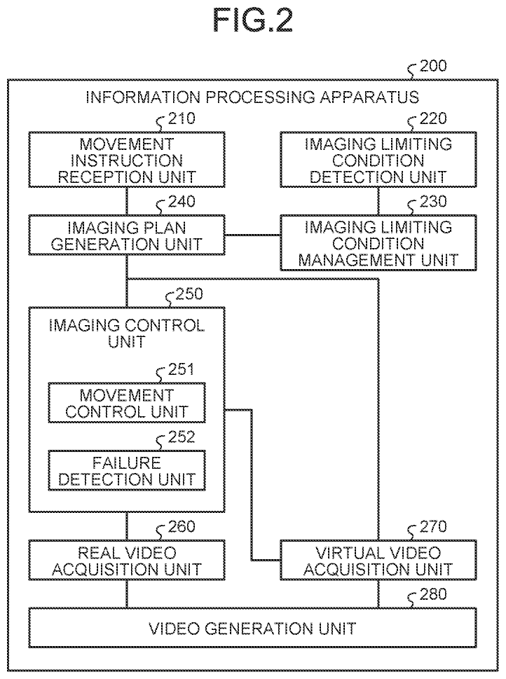

To cope with this, the embodiment realizes effective use of a real video and a virtual video by an information processing apparatus 200 that has functions as illustrated in FIG. 2. The information processing apparatus 200 operates in accordance with operation of a video creator (user).

FIG. 2 is an exemplary and schematic block diagram illustrating the functions of the information processing apparatus 200 according to the embodiment of the present disclosure. As illustrated in FIG. 2, the information processing apparatus 200 includes a movement instruction reception unit 210, an imaging limiting condition detection unit 220, an imaging limiting condition management unit 230, an imaging plan generation unit 240, an imaging control unit 250, a real video acquisition unit 260, and a virtual video acquisition unit 270.

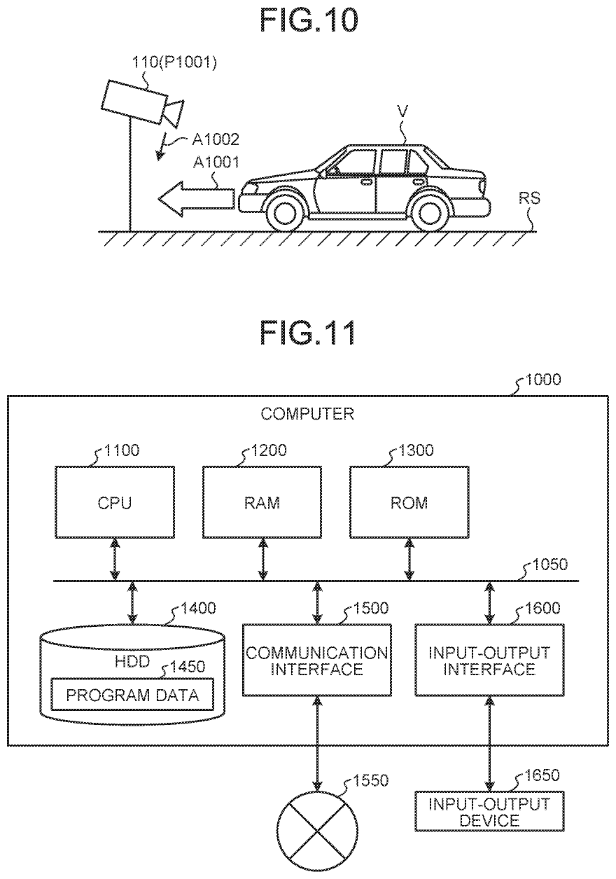

Each of the functions illustrated in FIG. 2 may be realized by cooperation of software and hardware in a computer 1000 (see FIG. 10) to be described later; however, in the embodiment, a part or all of the functions illustrated in FIG. 2 may be realized by dedicated hardware (circuitry).

The movement instruction reception unit 210 receives a movement instruction that is set in accordance with input operation performed by the video creator. The movement instruction is information indicating a camera work in a predetermined period that is designated by the video creator. The camera work is information indicating a state of a change of at least one of a viewpoint and a line of sight in the predetermined period. More specifically, the camera work is information including at least one of a set of a moving trajectory and a moving speed of the viewpoint in the predetermined period and a set of a change trajectory and a change rate of the line of sight in the predetermined period. Meanwhile, the predetermined period may be arbitrarily set to a short period or a long period.

The imaging limiting condition detection unit 220 detects an imaging limiting condition that represents a condition under which imaging by the imaging apparatus 110 is limited. The imaging limiting condition includes, for example, the imaging disapproved region that is set as a region in which imaging by the imaging apparatus 110 is disapproved, a speed limit that indicates a moving speed of a viewpoint (and a line of sight) of the imaging apparatus 110 in which imaging by the imaging apparatus 110 is impossible, and setting information related to the probability of occurrence of a failure due to a remaining amount of a battery of the imaging apparatus 110.

The imaging limiting condition management unit 230 performs management including retention and update of the imaging limiting condition detected by the imaging limiting condition detection unit 220.

The imaging plan generation unit 240 generates an imaging plan that indicates how to use the real video and the virtual video to generate a series of videos corresponding to the predetermined period, on the basis of the movement instruction received by the movement instruction reception unit 210 and the imaging limiting condition held by the imaging limiting condition management unit 230. While details will be described later, the imaging plan generation unit 240 generates an imaging plan to basically acquire a real video by causing the imaging apparatus 110 to perform imaging, and acquire a virtual video in place of the real video if imaging by the imaging apparatus 110 violates the imaging limiting condition.

The imaging control unit 250 includes a movement control unit 251 that controls movement of the imaging apparatus 110, and causes the movement control unit 251 to control imaging performed by the imaging apparatus 110 in accordance with the imaging plan generated by the imaging plan generation unit 240. Meanwhile, the imaging control unit 250 further includes a failure detection unit 252 that detects whether a failure has occurred in the imaging apparatus 110, but functions of the failure detection unit 252 will be described later.

The real video acquisition unit 260 acquires a real video that is captured by the imaging apparatus 110 under the control of the imaging control unit 250.

The virtual video acquisition unit 270 acquires a virtual video from the three-dimensional model that is generated based on real videos obtained by the plurality of imaging apparatuses 130. The virtual video is basically acquired in accordance with the imaging plan generated by the imaging plan generation unit 240 except when the failure detection unit 252 detects a failure.

A video generation unit 280 generates a series of videos in a predetermined period corresponding to the movement instruction given by the user, on the basis of the real video acquired by the real video acquisition unit 260 and the virtual video acquired by the virtual video acquisition unit 270. The generated videos are output to a display apparatus (not illustrated) that is connected to a communication interface 1500 or an input-output interface 1600 of the computer 1000 (see FIG. 10) (to be described later).

Here, in the embodiment, the imaging control unit 250 causes the imaging apparatus 110 to acquire a real video while moving at least one of the viewpoint and the line of sight in accordance with the movement instruction that is given by the user and that is received by the movement instruction reception unit 210. Further, if the imaging apparatus 110 approaches the imaging disapproved region while moving at least one of the viewpoint and the line of sight in accordance with the movement instruction, the video generation unit 280 generates a video in which the real video is continuously switched to a virtual video of an inside of the imaging disapproved region.

For example, a case is assumed in which the movement instruction received by the movement instruction reception unit 210 includes designation of a moving trajectory of at least the viewpoint. In this case, the imaging control unit 250 causes the imaging apparatus 110 to acquire a real video while moving at least the viewpoint along the moving trajectory designated in the movement instruction.

Then, if the viewpoint on the moving trajectory moves into the imaging disapproved region, the video generation unit 280 generates a video in which the real video is continuously switched to a virtual video corresponding to the viewpoint that is on the moving trajectory inside the imaging disapproved region. Further, the imaging control unit 250 prevents the imaging apparatus 110 from moving into the imaging disapproved region at a timing corresponding to switching from the real video to the virtual video that is performed in accordance with movement of the viewpoint into the imaging disapproved region.

Furthermore, if the viewpoint on the moving trajectory moves out of the imaging disapproved region, the video generation unit 280 generates a video in which the virtual video is continuously switched to a real video corresponding to the viewpoint that is on the moving trajectory outside the imaging disapproved region. Moreover, after preventing movement into the imaging disapproved region, the imaging control unit 250 causes the imaging apparatus 110 to move to the vicinity of an exit position, at which the viewpoint on the moving trajectory moves out of the imaging disapproved region, outside the imaging disapproved region, before a timing corresponding to switching from the virtual video to the real video.

Each of the functions as described above will be described in detail below with reference to specific examples.

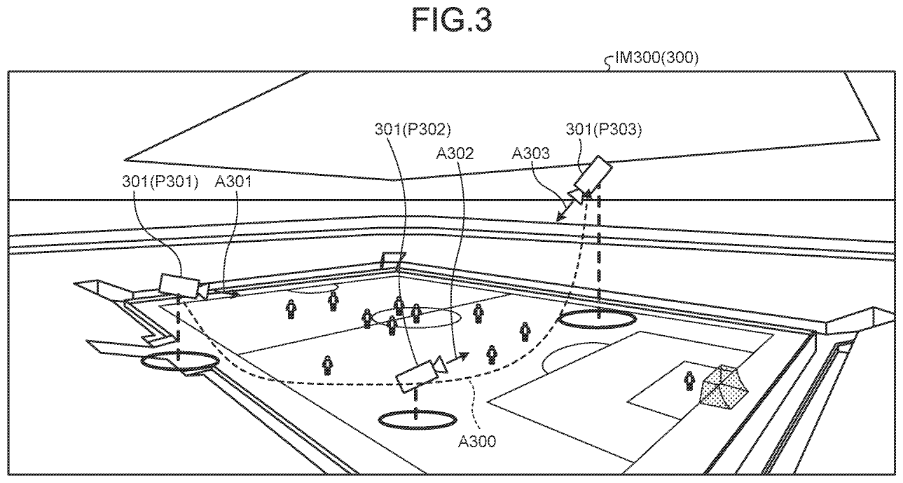

First, setting of the movement instruction by the video creator will be described in detail below. The movement instruction is set in accordance with input operation that is performed by the video creator via a setting screen IM300 as illustrated in FIG. 3, for example.

FIG. 3 is an exemplary and schematic diagram illustrating an example of the setting screen IM300 for setting the movement instruction according to the embodiment of the present disclosure. As illustrated in FIG. 3, the setting screen IM300 is displayed on a display apparatus 300 that includes a display screen on which a video is displayable.

Meanwhile, in the embodiment, the display apparatus 300 is connected to the communication interface 1500 or the input-output interface 1600 of the computer 1000 (see FIG. 10) (to be described later). The display apparatus 300 may be the same as or different from the above-described display apparatus to which the video generated by the video generation unit 280 is output. Further, in the embodiment, input of operation on the setting screen IM300 may be performed via an input device, such as a mouse, a keyboard, or a touch panel that is arranged on the display screen of the display apparatus 300 in an overlapping manner.

In the example illustrated in FIG. 3, an icon 301 representing a camera is displayed on the setting screen IM300. The icon 301 is configured such that a display mode (a position and an orientation) is arbitrarily adjusted in accordance with the input operation that is performed by the video creator via the input device as described above.

For example, if the position of the icon 301 is adjusted, the viewpoint in the camera work is adjusted, and, if the orientation of the icon 301 (a direction of a camera portion) is adjusted, the line of sight in the camera work is adjusted. In the example illustrated in FIG. 3, as one example, the moving trajectory of the viewpoint is represented by an arrow A300 that goes from a position P301 to a position P303 through a position P302, and orientations of the line of sight at the positions P301, P302, and P303 are represented by respective arrows A301, A302, and A303.

Meanwhile, while illustration is omitted in the example in FIG. 3, the setting screen IM300 may include a graphical user interface (GUI) for setting the moving speed of the viewpoint and the change rate of the line of sight.

Further, in the embodiment, as a method of setting the movement instruction, a method using a technology of hologram, augmented reality (AR), or a virtual reality (VR) may be adopted in addition to the method as illustrated in FIG. 3. With use of the technology as described above, for example, it is possible to display a model that represents the imaging target space and a model that represents the camera at the hand of the video creator (as miniature models). Further, in this case, by receiving operation input in which the video creator moves the model representing the camera while holding the model in his/her hand, it is possible to implement setting of the movement instruction corresponding to the operation input.

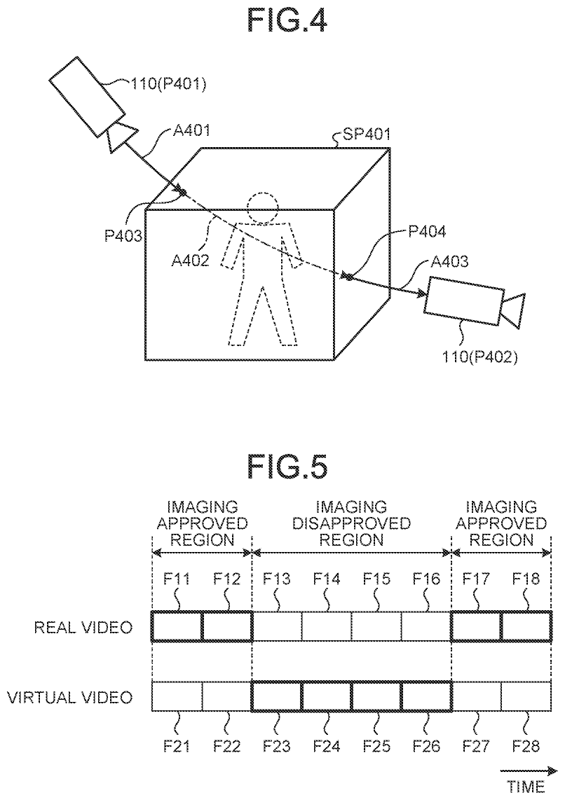

Next, the imaging disapproved region as one of references for switching between the real video and the virtual video will be described in detail below. In the embodiment, the imaging disapproved region is set with reference to an imaging target object of the imaging apparatus 110 as the real camera, in a mode as illustrated in FIG. 4, for example.

FIG. 4 is an exemplary and schematic diagram illustrating an example of the imaging disapproved region according to the embodiment of the present disclosure. In the example illustrated in FIG. 4, a human being X401 corresponds to an imaging target object and a space SP401 corresponds to the imaging disapproved region. A boundary of the space SP401 is defined by, for example, a distance from the human being X401. The distance may be fixedly set in advance or may be appropriately changed (updated) by the video creator.

In the example illustrated in FIG. 4, if the human being X401 moves, the space SP401 moves accordingly. Therefore, in this case, the imaging limiting condition detection unit 220 performs real-time image processing on at least one of a real video and a virtual video in which the human being X401 appears, detects a position of the human being X401, and detects the boundary of the space SP401 in accordance with the position of the human being X401.

Here, in the example illustrated in FIG. 4, a case will be described in which a moving trajectory represented by arrows A401 to A403 from a position P401 to a position P202 through the space SP401 are set by the movement instruction. In this case, in a region outside the boundary of the space SP401, in particular, in a region corresponding to the arrow A401 from the position P401 to an entrance position P403 of the space SP401 and a region corresponding to the arrow A403 from an exit position P404 of the space SP401 to the position P402, imaging by the imaging apparatus 110 is approved. However, in a region inside the boundary of the space SP401, in particular, a region corresponding to the arrow A402 from the entrance position P403 to the exit position P404, imaging by the imaging apparatus 110 is disapproved.

Therefore, in the example illustrated in FIG. 4, the imaging control unit 250 actually moves the imaging apparatus 110 along the arrow A401 and causes the imaging apparatus 110 to evacuate from the entrance position P403 to the outside of the space SP401 in order to prevent the imaging apparatus 110 from actually moving into the space SP401. Further, the imaging control unit 250 moves the imaging apparatus 110 to the vicinity of the exit position P404 before movement of the viewpoint along the arrow A402 in the virtual video is completed, and thereafter actually moves the imaging apparatus 110 along the arrow A403.

Meanwhile, if only the single imaging apparatus 110 is present, it is necessary to move the imaging apparatus 110 evacuated from the entrance position P403 to the vicinity of the exit position P404. However, if the plurality of imaging apparatuses 110 are present, it is sufficient to move, to the vicinity of the exit position P404, the imaging apparatus 110 other than the imaging apparatus 110 evacuated from the entrance position P403. In this case, it is most effective to move the imaging apparatus 110 located closest to the exit position P404 to the vicinity of the exit position P404.

In this manner, in the example illustrated in FIG. 4, the video generation unit 280 generates a series of videos corresponding to the entire moving trajectory represented by the arrows A401 to A403 by combining real videos of the regions corresponding to the arrows A401 and A403 and a virtual video of the region corresponding to the arrow A402. Accordingly, the video generation unit 280 generates the series of videos in a mode as illustrated in FIG. 5 as described below.

FIG. 5 is an exemplary and schematic diagram illustrating an example of a configuration of the series of videos according to the embodiment of the present disclosure. As illustrated in FIG. 5, in the embodiment, the video generation unit 280 is able to acquire both of a real video including frames F11 to F18 and a virtual video including frames F21 to F28 at the same timings as the respective frames F11 to F18.

As described above, the video generation unit 280 adopts the virtual video as the video of the inside of the imaging disapproved region, and adopts the real video as the video of the other regions, such as a region referred to as an imaging approved region, for example. Therefore, in the example illustrated in FIG. 5, the video generation unit 280 adopts the frames F11, F12, F17, and F18 of the real video in a period corresponding to the imaging approved region, and adopts the frames F23 to F26 of the virtual video in a period corresponding to the imaging disapproved region. In other words, in the example illustrated in FIG. 5, the video generation unit 280 generates a series of videos including the frames F11, F12, F23 to F26, F17, and F18.

Meanwhile, in the embodiment, the imaging plan generated by the imaging plan generation unit 240 may be regarded as the same concept as illustrated in FIG. 5. In other words, on the basis of the movement instruction and the imaging limiting condition as described above, the imaging plan generation unit 240 generates an imaging plan to cause the imaging apparatus 110 to perform imaging and cause the real video acquisition unit 260 to acquire the real video in an interval in which imaging by the imaging apparatus 110 is approved, and to cause the virtual video acquisition unit 270 to acquire the virtual video in an interval in which imaging by the imaging apparatus 110 is disapproved.

Meanwhile, the moving speed of the imaging apparatus 110 has a performance limit, and therefore, a speed limit exists, which indicates a moving speed of the viewpoint (and the line of sight) of the imaging apparatus 110 at which imaging by the imaging apparatus 110 is impossible. However, the movement instruction is arbitrarily set by the video creator, and therefore, in some cases, the moving speed of the viewpoint (and the line of sight) designated in the movement instruction may exceed the speed limit that is a threshold.

Therefore, in the embodiment, the imaging plan generation unit 240 generates an imaging plan to cause the virtual video acquisition unit 270 to acquire the virtual video in an interval in which the moving speed of the viewpoint (and the line of sight) designated in the movement instruction exceeds the speed limit. Then, at a subsequent imaging stage, if the moving speed of the viewpoint that is on the moving trajectory and moving outside the imaging disapproved region exceeds the speed limit, the video generation unit 280 generates a video in which the real video is continuously switched to the virtual video.

Furthermore, in the embodiment, if any failure has occurred due to the remaining amount of the battery or the like in the imaging apparatus 110 (or if it is expected that a failure will occur) at the stage of generating the imaging plan, it is difficult to normally control the imaging apparatus 110 at the subsequent imaging stage. Therefore, in this case, the imaging plan generation unit 240 generates an imaging plan to acquire the virtual video instead of the real video. Then, at the subsequent imaging stage, the video generation unit 280 generates a video in which the real video is continuously switched to the virtual video (or if a failure occurred from the beginning, a video including only the virtual video) at the subsequent imaging stage.

In this manner, the imaging plan generation unit 240 generates an imaging plan to acquire the real video in an interval in which the imaging limiting condition that is determined as described above with respect to the imaging disapproved region, the speed limit, a failure, and the like is violated, and to acquire the virtual image in other intervals. Accordingly, the video generation unit 280 generates a series of videos in which the real video and the virtual video are effectively used.

Meanwhile, in the embodiment, if any failure occurs in the imaging apparatus 110 at the actual imaging stage while the failure has not occurred at the stage of generating the imaging plan, the imaging apparatus 110 is not able to perform imaging. In this case, even if the imaging plan is determined to acquire the real video, it is necessary to acquire the virtual video.

To cope with this, referring back to FIG. 2, in the embodiment, the imaging control unit 250 includes the failure detection unit 252 that detects whether a failure has occurred in the imaging apparatus 110. Further, if the failure detection unit 252 detects occurrence of a failure in the imaging apparatus 110, the virtual video acquisition unit 270 acquires the virtual video independent of the imaging plan. Therefore, if a failure occurs in the imaging apparatus 110 that is moving in accordance with movement of the viewpoint that is on the moving trajectory outside the imaging disapproved region, the video generation unit 280 generates a video in which a real video is continuously switched to a virtual video corresponding to the current viewpoint and the current line of sight of the imaging apparatus 110.

In this manner, in the embodiment, a series of videos generated by the video generation unit 280 includes switching from the real video to the virtual video and switching form the virtual video to the real video, and in the latter switching, the imaging apparatus 110 may appear in the virtual video.

In particular, in the embodiment, as described above, the imaging apparatus 110 is caused to move to the vicinity of the exit position, at which the viewpoint on the moving trajectory moves out of the imaging disapproved region, outside the imaging disapproved region before a timing corresponding to the switching from the virtual video to the real video. Therefore, at the time of movement of the imaging apparatus 110 to the exit position, the imaging apparatus 110 may appear in the virtual video.

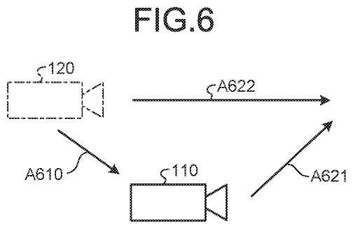

To cope with this, in the embodiment, for example, control as illustrated in FIG. 6 described below is performed at the time of switching from the virtual video to the real video, to thereby prevent the imaging apparatus 110 that is the real camera from appearing in a visual field of the virtual camera for the virtual video.

FIG. 6 is an exemplary and schematic diagram illustrating an example of control that is performed at the time of switching from the virtual video to the real video according to the embodiment of the present disclosure. In the example illustrated in FIG. 6, the imaging apparatus 110 as the real camera and the imaging apparatus 120 as the virtual camera are illustrated. Meanwhile, the point to note that the imaging apparatus 120 is illustrated only for the sake of convenience and does not really exist is the same as FIG. 1.

In the example illustrated in FIG. 6, control of moving the imaging apparatus 120 along an arrow A610 such that the imaging apparatus 120 joins up with the imaging apparatus 110 and control of moving the imaging apparatuses 110 and 120 along respective arrows A621 and A622 such that the imaging apparatuses 110 and 120 join up with each other are illustrated. By performing either one of the two kinds of control as described above, it is possible to prevent the imaging apparatus 110 from entering the visual field of the imaging apparatus 120 (immediately before joining up), so that it is possible to smoothly perform switching from the virtual video to the real video without giving a viewer a feeling of discomfort.

Furthermore, in the embodiment, not only at the time of switching from the virtual video to the real video, but also during a previous period in which the virtual video is adopted, the imaging apparatus 110 as the real camera is prevented from entering the visual field of the virtual camera in the virtual video from the same point of view as described above. In other words, in the embodiment, if the viewpoint on the moving trajectory is present in the imaging disapproved region, the imaging control unit 250 prevents the imaging apparatus 110 from directly appearing in the virtual video.

Meanwhile, the expression of “directly appearing” as described above indicates that an external appearance of the imaging apparatus 110 appears as it is. Therefore, in the embodiment, even if the imaging apparatus 110 appears in the virtual video, if image processing is performed such that, for example, the imaging apparatus 110 is displayed as a certain iconized image, a feeling of discomfort that may be given to the viewer is reduced, so that this measure is acceptable to some extent.

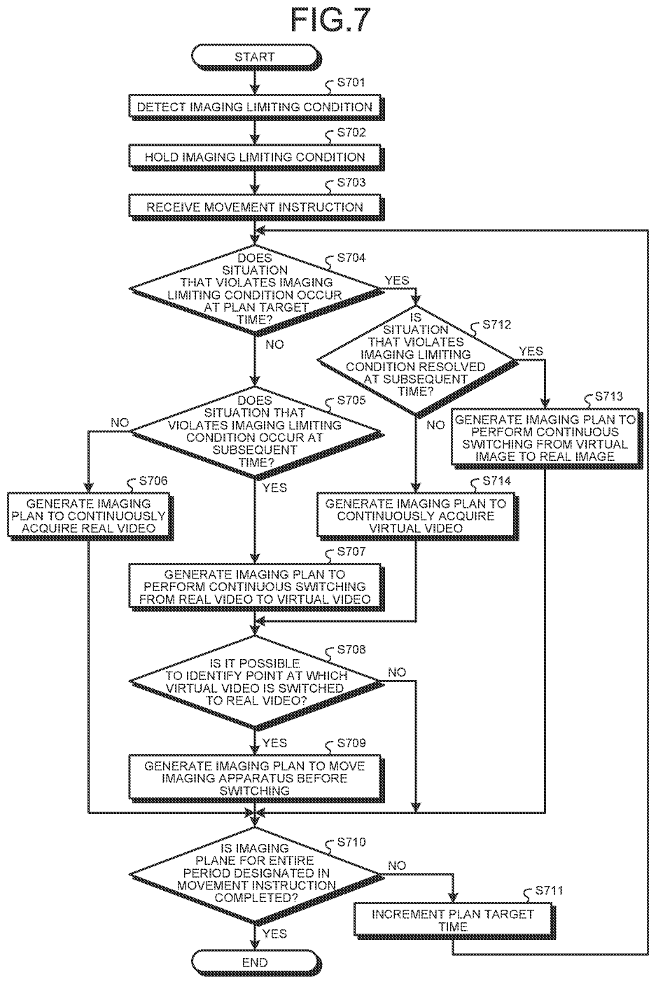

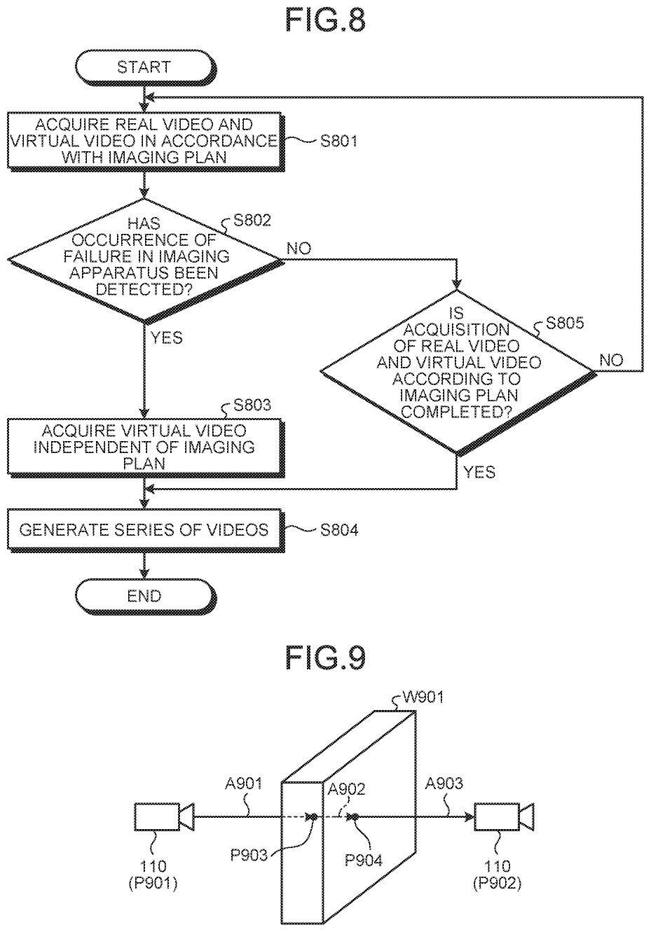

Based on the configuration as described above, in the embodiment, processes are performed in accordance with flowcharts as illustrated in FIG. 7 and FIG. 8 as described below.

FIG. 7 is an exemplary and schematic flowchart illustrating the flow of a process that is performed when the information processing apparatus 200 according to the embodiment of the present disclosure generates an imaging plan.

As illustrated in FIG. 7, when the imaging plan is to be generated in the embodiment, first, at Step S701, the imaging limiting condition detection unit 220 detects the imaging limiting condition including setting information on the imaging disapproved region, the speed limit, the possibility of occurrence of a failure, and the like as described above.

Further, at Step S702, the imaging limiting condition management unit 230 holds the imaging limiting condition detected at Step S701.

Then, at Step S703, the movement instruction reception unit 210 receives the movement instruction from the video creator (user) via, for example, the setting screen IM300 as described above (see FIG. 3) or the like.

Subsequently, at Step S704, the imaging plan generation unit 240 determines whether a situation that violates the imaging limiting condition occurs at a plan target time, on the basis of the imaging limiting condition held at Step S702 and the movement instruction received at Step S703. Meanwhile, the plan target time is, for example, an initial time for which it is not determined whether to acquire the real video or the virtual video during a predetermined period corresponding to the movement instruction. Further, the situation that violates the imaging limiting condition is, as described above, a situation in which the imaging apparatus 110 enters the imaging disapproved region, a situation in which the moving speed of the imaging apparatus 110 exceeds the speed limit, a situation in which any failure occurs in the imaging apparatus 110, or the like.

At Step S704, if it is determined that the situation that violates the imaging limiting condition does not occur at the plan target time, the process proceeds to Step S705. Then, at Step S705, the imaging plan generation unit 240 determines whether the situation that violates the imaging limiting condition occurs at a subsequent time of the plan target time.

At Step S705, if it is determined that the situation that violates the imaging limiting condition does not occur even at the subsequent time, the process proceeds to Step S706. Then, at Step S706, the imaging plan generation unit 240 generates an imaging plan to continuously acquire the real video at the plan target time and the subsequent time. Then, the process proceeds to Step S710 to be described later.

In contrast, at Step S705, if it is determined that the situation that violates the imaging limiting condition occurs at the subsequent time, the process proceeds to Step S707. Then, at Step S707, the imaging plan generation unit 240 generates an imaging plan to perform continuous switching from the real video to the virtual video, in other words, an imaging plan to acquire the real video at the plan target time and acquire the virtual video at the subsequent time.

Then, at Step S708, the imaging plan generation unit 240 determines whether it is possible to identify a point at which the virtual video is switched to the real video, for example, an exit position, an exit time, or the like at which the viewpoint that moves on the moving trajectory moves out of the imaging disapproved region.

At Step S708, if it is determined that it is possible to identify the exit position, the exit time, or the like as the point at which the virtual video is switched to the real video, the process proceeds to Step S709. Then, at Step S709, the imaging plan generation unit 240 generates an imaging plan to move the imaging apparatus 110 before the virtual video is switched to the real video, for example, an imaging plan to move the imaging apparatus 110 to the vicinity of the exit position before the exit time.

Then, at Step S710, the imaging plan generation unit 240 determines whether the imaging plan for the entire period that is designated in the movement instruction received at Step S703 is completed, in other words, determines whether a time for which it is not determined whether to acquire the real video or the virtual video is not present.

At Step S710, if it is determined that the imaging plan is completed, the process is terminated.

However, if it is determined that the imaging plan is not completed, the process proceeds to Step S711. Then, at Step S711, the imaging plan generation unit 240 increments the plan target time. Then, the process returns to Step S704.

In contrast, at Step S704, if it is determined that the situation that violates the imaging limiting condition occurs at the plan target time, the process proceeds to Step S712. Then, at Step S712, the imaging plan generation unit 240 determines whether the situation that violates the imaging limiting condition is resolved at the subsequent time of the plan target time.

At Step S712, if it is determined that the situation that violates the imaging limiting condition is resolved at the subsequent time, the process proceeds to Step S713. Then, at Step S713, the imaging plan generation unit 240 generates an imaging plan to perform continuous switching from the virtual video to the real video, in other words, an imaging plan to acquire the virtual video at the plan target time and acquire the real video at the subsequent time. Then, the process proceeds to Step S710.

In contrast, at Step S712, if it is determined that the situation that violates the imaging limiting condition is not resolved even at the subsequent time, the process proceeds to Step S714. Then, at Step S714, the imaging plan generation unit 240 generates an imaging plan to continuously acquire the virtual video at the plan target time and the subsequent time. Then, the process proceeds to Step S708.

In this manner, the imaging plan generation unit 240 according to the embodiment generates an entire imaging plan by repeatedly determining whether to acquire the real video or the virtual video at the plan target time and the subsequent time in the entire period that is designated in the movement instruction.

FIG. 8 is an exemplary and schematic flowchart illustrating the flow of a process that is performed when the information processing apparatus 200 according to the embodiment of the present disclosure generates a series of videos.

As illustrated in FIG. 8, in the embodiment, when a series of videos is to be generated in accordance with the imaging plan, first, at Step S801, the real video acquisition unit 260 and the virtual video acquisition unit 270 acquire the real video and the virtual video that are generated as a result of the process as illustrated in FIG. 7. The real video acquisition unit 260 acquires the real video that is captured by the moving imaging apparatus 110, and the virtual video acquisition unit 270 acquires the virtual video based on the three-dimensional model.

Here, at Step S802, the virtual video acquisition unit 270 determines whether the failure detection unit 252 of the imaging control unit 250 has detected occurrence of a failure in the imaging apparatus 110.

At Step S802, if it is determined that occurrence of a failure has been detected, the process proceeds to Step S803. Then, at Step S803, after detection of the occurrence of the failure, the virtual video acquisition unit 270 continuously acquires the virtual video independent of the imaging plan.

Then, at Step S804, the video generation unit 280 generates a series of videos by combining the real video and the virtual video acquired at Step S801 (and Step S803). Then, the process is terminated.

In contrast, at Step S802, if it is determined that occurrence of a failure has not been detected, the process proceeds to Step S805. Then, at Step S805, the real video acquisition unit 260 and the virtual video acquisition unit 270 determine whether acquisition of the real video and the virtual video according to the imaging plan is completed.

At Step S805, if it is determined that acquisition of the real video and the virtual video according to the imaging plan is not completed, the process returns to Step S801. However, at Step S805, if it is determined that acquisition of the real video and the virtual video according to the imaging plan is completed, the process proceeds to Step S804.

In this manner, the video generation unit 280 according to the embodiment generates a series of videos by acquiring the real video and the virtual video in accordance with or in not accordance with the imaging plan as needed basis while detecting occurrence of a failure, and by connecting the acquired real video and the acquired virtual video.

Meanwhile, the technology according to the embodiment as described above is also effectively applicable to a situation as illustrated in FIG. 9 below.

FIG. 9 is an exemplary and schematic diagram illustrating an example of application of the technology according to the embodiment of the present disclosure, which is different from FIG. 1. As illustrated in FIG. 9, the technology according to the embodiment is applicable even to a situation in which a series of videos as an image representing passage through a wall W901 is acquired, for example.

In the example illustrated in FIG. 9, it is assumed that a moving trajectory represented by arrows A901 to A903 on which the imaging apparatus 110 moves from a position P901 to a position P902 through an internal portion of the wall W901 is set in the movement instruction. It is physically impossible for the imaging apparatus 110 to perform imaging of (enter) the internal portion of the wall W901, and the internal portion corresponds to the imaging disapproved region as described above.

Therefore, in the example illustrated in FIG. 9, a virtual video is acquired in a region corresponding to the arrow A902 from an entrance position P903 of the wall W901 to an exit position P904 of the wall W901. It may be possible to cause the imaging apparatus 110 to wait in the vicinity of the exit position P904 in advance, at the time of switching from the virtual video to the real video at the exit position P904, which is the same as the example as illustrated in FIG. 4 as described above.

Meanwhile, the examples illustrated in FIG. 4 and FIG. 9 as described above correspond to an example in which the movement instruction including movement of the viewpoint is set. However, the technology according to the embodiment is also effectively applicable to an example in which the movement instruction does not include movement of the viewpoint as illustrated in FIG. 10 below.

FIG. 10 is an exemplary and schematic diagram illustrating an example of application of the technology according to the embodiment of the present disclosure, which is different from FIG. 1 and FIG. 9. In the example illustrated in FIG. 10, an example of a situation is illustrated in which the imaging apparatus 110 installed at a position P1001 captures an image of a vehicle V that travels along an arrow A1001 on a road surface RS. While illustration is omitted in FIG. 10, the imaging disapproved region based on the vehicle V is set with respect to the vehicle V, similarly to the example as illustrated in FIG. 4 or the like as described above.

In the example illustrated in FIG. 10, it is assumed that a movement instruction for fixing the viewpoint of the imaging apparatus 110 and moving only the line of sight along an arrow A1002 is set. In this case, if the vehicle V travels to some extent, it is expected that the imaging apparatus 110 enters the imaging disapproved region of the vehicle V even though the position of the imaging apparatus 110 is not changed.

To cope with this, in the example illustrated in FIG. 10, by adopting the real video in an interval before the imaging apparatus 110 enters the imaging disapproved region of the vehicle V and adopting the virtual video in other intervals, it is possible to acquire a series of videos in which the traveling vehicle V is captured from the fixed viewpoint. Further, with this configuration, even in a case in which the vehicle V and the imaging apparatus 110 crash with each other and a failure occurs in the imaging apparatus 110, it is possible to obtain, by using the virtual video, a series of videos in which the traveling vehicle V is captured from the fixed viewpoint, without any problem.

As described above, the information processing apparatus 200 according to the embodiment includes the imaging control unit 250 and the video generation unit 280. The imaging control unit 250 causes the imaging apparatus 110 that is a real camera to acquire a real video while moving at least one of the viewpoint and the line of sight in accordance with the movement instruction given by the video creator (user). The video generation unit 280 generates a video in which the real video is continuously switched to a virtual video of an inside of the imaging disapproved region when the imaging apparatus 110 approaches the imaging disapproved region while moving at least one of the viewpoint and the line of sight in accordance with the movement instruction. Meanwhile, the imaging disapproved region is a region that is set as a region in which imaging by the imaging apparatus 110 is disapproved.

With this configuration as described above, it is possible to effectively use the real video and the virtual video depending on whether the imaging apparatus 110 that is performing imaging approaches the imaging disapproved region. For example, by effectively using the virtual video, which tends to have lower quality than the real video but for which camera work is not limited, and the real video, which tends to have higher quality than the virtual video, it is possible to generate a series of videos for which entire quality is improved.

Furthermore, in the embodiment, as described above, the imaging control unit 250 may cause the imaging apparatus 110 to acquire the real video while moving at least the viewpoint along the moving trajectory that is designated in the movement instruction. In this case, when the viewpoint on the moving trajectory moves into the imaging disapproved region, the video generation unit 280 generates a video in which the real video is continuously switched to a virtual video corresponding to the viewpoint that is on the moving trajectory inside the imaging disapproved region. With this configuration, it is possible to appropriately perform switching from the real video to the virtual video in accordance with movement of the viewpoint into the imaging disapproved region.

In the configuration as described above, the imaging control unit 250 causes the imaging apparatus 110 to avoid moving into the imaging disapproved region at a timing corresponding to switching from the real video to the virtual video that is performed in accordance with movement of the viewpoint into the imaging disapproved region. With this configuration, it is possible to prevent the imaging apparatus 110 from actually moving into the imaging disapproved region in accordance with the viewpoint of the video.

Furthermore, in the configuration as described above, when the viewpoint on the moving trajectory moves out of the imaging disapproved region, the video generation unit 280 generates the video in which the virtual video is continuously switched to the real video corresponding to the viewpoint that is on the moving trajectory outside the imaging disapproved region. With this configuration, it is possible to appropriately perform switching from the virtual video to the real video in accordance with movement of the viewpoint out of the imaging disapproved region.

Moreover, in the configuration as described above, the imaging control unit 250 causes the imaging apparatus 110 to move to the vicinity of the exit position outside the imaging disapproved region after avoiding movement into the imaging disapproved region and before a timing corresponding to switching from the virtual video to the real video, where the exit position is a position at which the viewpoint on the moving trajectory moves out of the imaging disapproved region. With this configuration, by moving, in advance, the imaging apparatus 110 to the vicinity of the exit position outside the imaging disapproved region, it is possible to easily acquire the real video after the virtual video.

Furthermore, in the configuration as described above, when the plurality of imaging apparatuses 110 are present so as to be able to move independently of each other, the imaging control unit 250 causes any one of the imaging apparatuses 110 to move to the vicinity of the exit position outside the imaging disapproved region. With this configuration, it is possible to prevent inefficiency of moving all of the plurality of imaging apparatuses 110 to the vicinity of the exit position outside the imaging disapproved region, for example.

Moreover, in the configuration as described above, the imaging control unit 250 causes the single imaging apparatus 110 that is located closest to the exit position among the plurality of imaging apparatuses 110 to move to the vicinity of the exit position outside the imaging disapproved region. With this configuration, it is possible to more effectively move the single imaging apparatus 110 to the vicinity of the exit position outside the imaging disapproved region.

Furthermore, in the configuration as described above, when the viewpoint on the moving trajectory is present inside the imaging disapproved region, the imaging control unit 250 causes the imaging apparatus 110 to avoid directly appearing in the virtual video. With this configuration, it is possible to prevent the imaging apparatus 110 that has directly appeared in the virtual video from giving a viewer a feeling of discomfort.

Moreover, in the configuration as described above, the movement instruction includes designation of a moving speed of the viewpoint along the moving trajectory. Further, if the moving speed of the viewpoint that is on the moving trajectory and is moving outside the imaging disapproved region exceeds a threshold, the video generation unit 280 generates the video in which the real video is continuously switched to the virtual video. With this configuration, for example, in a case in which the moving speed of the viewpoint exceeds the threshold and it becomes difficult for the imaging apparatus 110 that is moving in accordance with the movement of the viewpoint to perform imaging, it is possible to adopt the virtual video in place of the real video.

Furthermore, in the configuration as described above, if a failure occurs in the imaging apparatus that is moving in accordance with the movement of the viewpoint that is on the moving trajectory outside the imaging disapproved region, the video generation unit 280 generates a video in which the real video is continuously switched to the virtual video. With this configuration, in a case in which it is difficult for the imaging apparatus 110 to perform imaging due to occurrence of the failure, it is possible to adopt the virtual video in place of the real video.

Moreover, in the configuration as described above, the imaging disapproved region is set with reference to an imaging target object of the imaging apparatus 110. With this configuration, even when the imaging target object moves, it is possible to appropriately determine the imaging disapproved region.

Furthermore, in the configuration as described above, the virtual video is acquired based on the three-dimensional model of an imaging target space to be captured by the imaging apparatus 110. With this configuration, it is possible to easily acquire the virtual video corresponding to an arbitrary viewpoint (and a line of sight) inside the imaging target space on the basis of the three-dimensional model.

Moreover, in the configuration as described above, the three-dimensional model is generated based on at least one of the real video that is acquired by the imaging apparatus 110 and the real video that is acquired by the plurality of imaging apparatuses 130 that are arranged so as to surround the imaging target space and that are different from the imaging apparatus 110. With this configuration, it is possible to easily generate the three-dimensional model on the basis of at least one of the two kinds of imaging apparatuses.

Furthermore, in the configuration as described above, the movement instruction is set in accordance with input operation that is performed by a user via the setting screen IM300 displayed on the display apparatus 300 as illustrated in FIG. 3, for example. With this configuration, it is possible to easily set the movement instruction by a visual method.

Moreover, in the configuration as described above, the imaging apparatus 110 is, for example, a drone that is an air vehicle equipped with a camera. With this configuration, it is possible to flexibly perform imaging by the drone that is able to make a short turn.

Meanwhile, operational results (effects) derived from the configuration of the embodiments as described above are one example, and not limited to the contents as described above.

For example, in the embodiment as described above, while explanation related to a voice is not specifically described, the technology according to the embodiment may be applied to switching between a real voice and a virtual voice based on the same idea as the switching between the real video and the virtual video. Meanwhile, the real voice is an actual voice that is acquired by a physical microphone, and the virtual voice is a virtual voice at an arbitrary position that is calculated based on a plurality of real voices acquired by a plurality of physical microphones.

Furthermore, in the embodiment as described above, it may be possible to adopt a configuration in which the virtual video is not continuously acquired, but is acquired only when it is difficult to acquire the real video, for power saving.

Moreover, in the embodiment as described above, an example is illustrated in which the real video is switched to the virtual video when the situation that violates the imaging limiting condition occurs, and the virtual video is switched to the real video when the situation is resolved. However, for example, switching in a scene that may be used as a highlight may give a viewer a feeling of discomfort, so that the timing of switching between the real video and the virtual video may be adjusted by performing the switching at an earlier timing or a delayed timing, in accordance with situations.

Furthermore, in the embodiment as described above, for example, in a case in which fog occurs in only around the imaging apparatus 110, quality of the virtual video may be higher than the real video. In this case, it may be possible to adopt a configuration in which any index for evaluating the quality of the real video and the quality of the virtual video is calculated, and the virtual video is adopted in accordance with the index even if the real video is expected to be adopted in the imaging plan.

Here, as described above, the information processing apparatus 200 according to the embodiment may be realized by the computer 1000 configured as illustrated in FIG. 11 below, for example.

FIG. 11 is a hardware configuration diagram illustrating an example of the computer 1000 that implements the functions of the information processing apparatus 200 according to the embodiment of the present disclosure. As illustrated in FIG. 11, the computer 1000 includes a central processing unit (CPU) 1100, a random access memory (RAM) 1200, a read only memory (ROM) 1300, a hard disk drive (HDD) 1400, the communication interface 1500, and the input-output interface 1600. All of the units of the computer 1000 are connected to one another via a bus 1050.

The CPU 1100 operates based on a program that is stored in the ROM 1300 or the HDD 1400, and controls each of the units. For example, the CPU 1100 loads the program stored in the ROM 1300 or the HDD 1400 onto the RAM 1200, and performs processes corresponding to the various programs.

The ROM 1300 stores therein a boot program, such as Basic Input Output System (BIOS), that is executed by the CPU 1100 at the time of activation of the computer 1000, a program that depends on the hardware of the computer 1000, and the like.

The HDD 1400 is a computer readable recording medium that non-transitory records therein a program executed by the CPU 1100, data used by the program, and the like. Specifically, the HDD 1400 is a recording medium that records therein the information processing program according to the embodiment, which is one example of program data 1450.

The communication interface 1500 is an interface for connecting the computer 1000 to an external network 1550 (for example, the Internet). For example, the CPU 1100 receives data from a different apparatus or transmits data generated by the CPU 1100 to a different device, via the communication interface 1500.

The input-output interface 1600 is an interface for connecting the input-output device 1650 and the computer 1000. For example, the CPU 1100 receives data from an input device, such as a keyboard or a mouse, via the input-output interface 1600. Further, the CPU 1100 transmits data to an output device, such as a display apparatus, a speaker, or a printer, via the input-output interface 1600. Further, the input-output interface 1600 may function as a media interface that reads a program recorded in a predetermined recording medium (medium). Examples of the medium include an optical recording medium, such as a digital versatile disc (DVD) or a phase change rewritable disk (PD), a magneto optical recording medium such as a magneto-optical disk (MO), a tape medium, a magnetic recording medium, and a semiconductor memory.

For example, if the computer 1000 functions as the information processing apparatus 200 according to the embodiment, the CPU 1100 of the computer 1000 executes an information processing program loaded on the RAM 1200 and implements each of the functions as illustrated in FIG. 2. Furthermore, the HDD 1400 stores therein the information processing program according to the present disclosure and data in the content storage unit 121. Meanwhile, the CPU 1100 reads the program data 1450 from the HDD 1400 and executes the program data, but as an alternative example, it may be possible to acquire the programs from a different device via the external network 1550.

Additionally, the present technology may also be configured as below.

(1)

An information processing apparatus comprising:

an imaging control unit that causes a first imaging apparatus to acquire a real video while moving at least one of a viewpoint and a line of sight in accordance with a movement instruction given by a user; and

a video generation unit that, when the first imaging apparatus approaches an imaging disapproved region, the imaging disapproved region being set as a region in which imaging by the first imaging apparatus is disapproved, while moving at least one of the viewpoint and the line of sight in accordance with the movement instruction, generates a video in which the real video is continuously switched to a virtual video of an inside of the imaging disapproved region.

(2)

The information processing apparatus according to (1), wherein

the imaging control unit causes the first imaging apparatus to acquire the real video while moving at least the viewpoint along a moving trajectory that is designated in the movement instruction, and

when the viewpoint on the moving trajectory moves into the imaging disapproved region, the video generation unit generates the video in which the real video is continuously switched to a virtual video corresponding to the viewpoint that is on the moving trajectory inside the imaging disapproved region.

(3)

The information processing apparatus according to (2), wherein the imaging control unit causes the first imaging apparatus to avoid moving into the imaging disapproved region at a timing corresponding to switching from the real video to the virtual video, the switching being performed in accordance with movement of the viewpoint into the imaging disapproved region.

(4)

The information processing apparatus according to (3), wherein when the viewpoint on the moving trajectory moves out of the imaging disapproved region, the video generation unit generates the video in which the virtual video is continuously switched to the real video corresponding to the viewpoint that is on the moving trajectory outside the imaging disapproved region.

(5)

The information processing apparatus according to (4), wherein the imaging control unit causes the first imaging apparatus to move to a vicinity of an exit position outside the imaging disapproved region after avoiding movement into the imaging disapproved region and before a timing corresponding to switching from the virtual video to the real video, the exit position being a position at which the viewpoint on the moving trajectory moves out of the imaging disapproved region.

(6)

The information processing apparatus according to (5), wherein when the first imaging apparatus includes a plurality of first imaging apparatuses that are able to move independently of each other, the imaging control unit causes any one of the first imaging apparatuses to move to the vicinity of the exit position outside the imaging disapproved region.

(7)

The information processing apparatus according to (6), wherein the imaging control unit causes the single first imaging apparatus that is located closest to the exit position among the plurality of first imaging apparatuses to move to the vicinity of the exit position outside the imaging disapproved region.

(8)

The information processing apparatus according to any one of (3) to (7), wherein when the viewpoint on the moving trajectory is present inside the imaging disapproved region, the imaging control unit causes the first imaging apparatus to avoid directly appearing in the virtual video.

(9)

The information processing apparatus according to any one of (2) to (8), wherein

the movement instruction includes designation of a moving speed of the viewpoint along the moving trajectory, and

if the moving speed of the viewpoint that is on the moving trajectory and is moving outside the imaging disapproved region exceeds a threshold, the video generation unit generates the video in which the real video is continuously switched to the virtual video.

(10)

The information processing apparatus according to any one of (2) to (9), wherein if a failure occurs in the first imaging apparatus that is moving in accordance with movement of the viewpoint that is on the moving trajectory and moving outside the imaging disapproved region, the video generation unit generates a video in which the real video is continuously switched to the virtual video.

(11)

The information processing apparatus according to any one of (2) to (10), wherein the imaging disapproved region is set with reference to an imaging target object of the first imaging apparatus.

(12)

The information processing apparatus according to any one of (1) to (11), wherein the virtual video is acquired based on a three-dimensional model of an imaging target space to be captured by the first imaging apparatus.

(13)

The information processing apparatus according to (12), wherein the three-dimensional model is generated based on at least one of the real video that is acquired by the first imaging apparatus and the real video that is acquired by a plurality of second imaging apparatuses, the second imaging apparatuses being arranged so as to surround the imaging target space and being different from the first imaging apparatus.

(14)

The information processing apparatus according to any one of (1) to (13), wherein the movement instruction is set in accordance with input operation that is performed by the user via a setting screen displayed on a display apparatus.

(15)

The information processing apparatus according to any one of (1) to (14), wherein the first imaging apparatus includes a drone that is an air vehicle equipped with a camera.

(16)

A method comprising:

an imaging control step of causing a first imaging apparatus to acquire a real video while moving at least one of a viewpoint and a line of sight in accordance with a movement instruction given by a user; and

a video generation step of generating, when the first imaging apparatus approaches an imaging disapproved region that is set as a region in which imaging by the first imaging apparatus is disapproved while moving at least one of the viewpoint and the line of sight in accordance with the movement instruction, a video in which the real video is continuously switched to a virtual video of an inside of the imaging disapproved region.

(17)

A non-transitory computer readable recording medium that stores therein a program that instructs a computer to execute:

an imaging control step of causing a first imaging apparatus to acquire a real video while moving at least one of a viewpoint and a line of sight in accordance with a movement instruction given by a user; and

a video generation step of generating, when the first imaging apparatus approaches an imaging disapproved region that is set as a region in which imaging by the first imaging apparatus is disapproved while moving at least one of the viewpoint and the line of sight in accordance with the movement instruction, a video in which the real video is continuously switched to a virtual video of an inside of the imaging disapproved region.

### REFERENCE SIGNS LIST

110 imaging apparatus (first imaging apparatus)
130 imaging apparatus (second imaging apparatus)
200 information processing apparatus
250 imaging control unit
280 video generation unit
300 display apparatus
IM300 setting screen

1. An information processing apparatus comprising:
an imaging control unit that causes a first imaging apparatus to acquire a real video while moving at least one of a viewpoint and a line of sight in accordance with a movement instruction given by a user; and
a video generation unit that, when the first imaging apparatus approaches an imaging disapproved region, the imaging disapproved region being set as a region in which imaging by the first imaging apparatus is disapproved, while moving at least one of the viewpoint and the line of sight in accordance with the movement instruction, generates a video in which the real video is continuously switched to a virtual video of an inside of the imaging disapproved region.

2. The information processing apparatus according to claim 1, wherein
the imaging control unit causes the first imaging apparatus to acquire the real video while moving at least the viewpoint along a moving trajectory that is designated in the movement instruction, and
when the viewpoint on the moving trajectory moves into the imaging disapproved region, the video generation unit generates the video in which the real video is continuously switched to a virtual video corresponding to the viewpoint that is on the moving trajectory inside the imaging disapproved region.

3. The information processing apparatus according to claim 2, wherein the imaging control unit causes the first imaging apparatus to avoid moving into the imaging disapproved region at a timing corresponding to switching from the real video to the virtual video, the switching being performed in accordance with movement of the viewpoint into the imaging disapproved region.

4. The information processing apparatus according to claim 3, wherein when the viewpoint on the moving trajectory moves out of the imaging disapproved region, the video generation unit generates the video in which the virtual video is continuously switched to the real video corresponding to the viewpoint that is on the moving trajectory outside the imaging disapproved region.

5. The information processing apparatus according to claim 4, wherein the imaging control unit causes the first imaging apparatus to move to a vicinity of an exit position outside the imaging disapproved region after avoiding movement into the imaging disapproved region and before a timing corresponding to switching from the virtual video to the real video, the exit position being a position at which the viewpoint on the moving trajectory moves out of the imaging disapproved region.

6. The information processing apparatus according to claim 5, wherein when the first imaging apparatus includes a plurality of first imaging apparatuses that are able to move independently of each other, the imaging control unit causes any one of the first imaging apparatuses to move to the vicinity of the exit position outside the imaging disapproved region.

7. The information processing apparatus according to claim 6, wherein the imaging control unit causes the single first imaging apparatus that is located closest to the exit position among the plurality of first imaging apparatuses to move to the vicinity of the exit position outside the imaging disapproved region.

8. The information processing apparatus according to claim 3, wherein when the viewpoint on the moving trajectory is present inside the imaging disapproved region, the imaging control unit causes the first imaging apparatus to avoid directly appearing in the virtual video.

9. The information processing apparatus according to claim 2, wherein
the movement instruction includes designation of a moving speed of the viewpoint along the moving trajectory, and
if the moving speed of the viewpoint that is on the moving trajectory and is moving outside the imaging disapproved region exceeds a threshold, the video generation unit generates the video in which the real video is continuously switched to the virtual video.

10. The information processing apparatus according to claim 2, wherein if a failure occurs in the first imaging apparatus that is moving in accordance with movement of the viewpoint that is on the moving trajectory and moving outside the imaging disapproved region, the video generation unit generates a video in which the real video is continuously switched to the virtual video.

11. The information processing apparatus according to claim 2, wherein the imaging disapproved region is set with reference to an imaging target object of the first imaging apparatus.

12. The information processing apparatus according to claim 1, wherein the virtual video is acquired based on a three-dimensional model of an imaging target space to be captured by the first imaging apparatus.

13. The information processing apparatus according to claim 12, wherein the three-dimensional model is generated based on at least one of the real video that is acquired by the first imaging apparatus and the real video that is acquired by a plurality of second imaging apparatuses, the second imaging apparatuses being arranged so as to surround the imaging target space and being different from the first imaging apparatus.

14. The information processing apparatus according to claim 1, wherein the movement instruction is set in accordance with input operation that is performed by the user via a setting screen displayed on a display apparatus.

15. The information processing apparatus according to claim 1, wherein the first imaging apparatus includes a drone that is an air vehicle equipped with a camera.

16. A method comprising:
an imaging control step of causing a first imaging apparatus to acquire a real video while moving at least one of a viewpoint and a line of sight in accordance with a movement instruction given by a user; and
a video generation step of generating, when the first imaging apparatus approaches an imaging disapproved region that is set as a region in which imaging by the first imaging apparatus is disapproved while moving at least one of the viewpoint and the line of sight in accordance with the movement instruction, a video in which the real video is continuously switched to a virtual video of an inside of the imaging disapproved region.

17. A non-transitory computer readable recording medium that stores therein a program that instructs a computer to execute:
an imaging control step of causing a first imaging apparatus to acquire a real video while moving at least one of a viewpoint and a line of sight in accordance with a movement instruction given by a user; and
a video generation step of generating, when the first imaging apparatus approaches an imaging disapproved region that is set as a region in which imaging by the first imaging apparatus is disapproved while moving at least one of the viewpoint and the line of sight in accordance with the movement instruction, a video in which the real video is continuously switched to a virtual video of an inside of the imaging disapproved region.
